(19) United States
(12) Patent Application Publication
(10) Pub. No.: US 2006/0115772 A1
(43) Pub. Date: Jun. 1, 2006

(54) Polymeric tetrahedral carbon films, methods of forming the same and methods of forming fine patterns using the same

(75) Inventors: Jung-Hwan Hah, Gyeonggi-do (KR); Yool Kang, Gyeonggi-do (KR); Man-Hyoung Ryoo, Gyeonggi-do (KR); Shi-Yong Yi, Gyeonggi-do (KR); Sang-Gyun Woo, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/282,368

(22) Filed: Nov. 18, 2005

(30) Foreign Application Priority Data
Nov. 26, 2004 (KR) 10-2004-0097946

(51) Int. Cl. G03C 5/00

(52) U.S. Cl. 430/311

(57) ABSTRACT

The present invention provides polymeric films including polymers having an sp³ carbon main frame including a tetrahedral center atom. Methods of forming the same, hard marks including the same and methods of forming fine patterns using the same are also provided.

### CROSS-REFERENCE TO RELATED APPLICATION

This application claims the benefit of Korean Patent Application No. 10-2004-0097946, filed on Nov. 26, 2004, the disclosure of which is incorporated by reference herein in its entirety.

### FIELD OF THE INVENTION

The present invention relates to polymeric films for use as a hard mask material, methods of forming the same and methods of forming fine patterns.

### BACKGROUND OF THE INVENTION

Due, at least in part, to high integration of semiconductor devices, it is desirable to form a smaller-sized pattern, for example, a sub-micron sized pattern for embodying high integrated circuits. In view of the reduction of pattern size, it is further desirable to gradually decrease photoresist thickness, which may be used in a photolithography process in an attempt to control pattern resolution. The photolithography process may utilize a pattern size less than 100 nm, and therefore, an exposure using an ArF excimer laser having a wavelength of 193 nm may be routinely employed. Accordingly, research has been directed to elucidating processes that use a hard mask to facilitate pattern transfer to an underlying layer. See U.S. Pat. Nos. 6,573,030 and 6,764,939.

Conventional methods may utilize amorphous carbon such as graphite and poly(arylene ether) (PAE) as a hard mask material for etching a silicon oxide film, a silicon nitride film, or a metallic film. An amorphous carbon film may be formed including an olefin-based hydrocarbon such as propylene during plasma-enhanced chemical vapor deposition (PECVD), and its final structure may be a conjugated sp² carbon structure as shown in FIG. 1. A PAE film may be formed using a spin-on process, and may have a polymeric structure of arylene ether as shown in FIG. 2. The PAE film of FIG. 2 has the same or substantially similar conjugated sp² carbon structure as the amorphous carbon film of FIG. 1. In a hard mask having the conjugated sp² carbon structure, conjugation and aromatization may progress, and accordingly, a carbon-to-hydrogen ratio (C/H ratio) may be increased and the carbon content may be increased, thereby securing resistance against dry etching.

A hard mask having the conjugated sp² carbon structure, such as the amorphous carbon film and the PAE film, may present several drawbacks. For example, if a curing temperature of the hard mask is increased or cross-linkage is increased so as to increase the carbon content by increasing the C/H ratio, the conjugation and pseudo-conjugation may be increased. Accordingly, as shown in FIG. 3, an energy gap of π−π* transition may be decreased. Thus, absorbance may be increased at longer wavelengths, and as a result, the hard mask may be opaque at a wavelength of about 633 nm. At a wavelength of about 633 nm, an interlayer alignment may be performed during the manufacturing process of semiconductor devices. However, when the amorphous carbon film and the PAE film are used as the hard mask, it may be problematic to perform the interlayer alignment.

A PAE film having a lower carbon content than the amorphous carbon film may have less misalignment than the amorphous carbon film due, at least in part, to its smaller absorbance at longer wavelengths. However, the PAE film may have a drawback in that it may be problematic to secure the resistance against the dry etching due, at least in part, to its lower carbon content. In order to address this issue, if the curing temperature or the cross-linkage is increased, thereby increasing the carbon content, the conjugation and the pseudo-conjugation may be increased. Similar to the amorphous carbon film, the PAE film may present a drawback in absorbance. More specifically, in the hard mask having a conjugated sp² carbon structure main frame, it may be problematic to concurrently satisfy two objects of the resistance against the dry etching and the interlayer alignment in the manufacturing process of semiconductor devices. Therefore, development of a newly structured hard mask material is desirable.

### SUMMARY OF THE INVENTION

According to some embodiments, the present invention provides polymeric hard mask films including a polymer having an sp³ carbon main frame including a tetrahedral center atom. It may be less problematic to dissolve a polymeric material including the polymeric film in an organic solvent. Accordingly, the polymeric hard mask film can be spin-coated on a substrate wherein the organic liquid is dissolved in the organic solvent. Therefore, the polymeric hard mask film according to some embodiments of the present invention may be more amenable to use in the film forming process than a conventional hard mask film. As compared with a hard mask including the conjugated sp² amorphous carbon, a polymeric hard mask film according to some embodiments of the present invention may not have the π−π* transition, and thus, absorbance at longer wavelengths may be minimized. Accordingly, there may be decreased difficulty associated with the interlayer alignment when the semiconductor device is manufactured. Thus, when a fine pattern is formed using the hard mask including a polymeric film according to some embodiments of the present invention, the interlayer alignment may be more effectively formed. The increased carbon content may be secured within the hard mask, thereby providing sufficient resistance against dry etching.

In some embodiments, a polymeric film according to some embodiments of the present invention includes a polymer having an sp³ carbon main frame further including a tetrahedral center atom. In some embodiments, the polymer includes a poly(hydridocarbyne) having a carbon compound repeating unit according to the following formula:

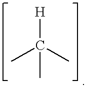

In some embodiments, the polymer includes a carbon compound repeating unit according to the following formula: 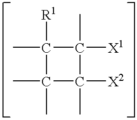
wherein:

R¹ is an aliphatic, alicyclic or aromatic group having a formula of C_{n′}H₍₂ₙ₊₁₎ or C₆HₘR²₍₅₋ₘ₎, wherein R² is a halide, hydroxy, nitryl or carboxyl group, n′ is an integer from 5 to 15 and m is an integer from 0 to 5; and

X¹ and X² are each independently a halogen.

Some embodiments of the present invention further provide methods of forming a polymeric film for a hard mask in which its preparation can be facilitated using a newly structured material, and resistance against dry etching can be secured while an interlayer alignment can be effectively performed. In some embodiments, the method includes forming the polymeric film including an sp³ carbon main frame further including a tetrahedral center atom, on a substrate and curing the polymeric film at a temperature in a range of about 200° C. to 300° C.

Further, the present invention provides methods for forming a fine pattern using a newly structured hard mask material in which resistance against dry etching can be secured while an interlayer alignment can be effectively performed. According to some embodiments of the present invention, methods of forming a fine pattern include forming an etching-target film on a substrate; forming a hard mask layer including a polymeric film including an sp³ carbon main frame further including a tetrahedral center atom, on the etching-target film; forming an anti-reflective coating on the etching-target film; forming a photoresist film on the anti-reflective coating; exposing and developing the photoresist film to form a photoresist pattern; sequentially etching the anti-reflective coating and the hard mask layer using the photoresist pattern as an etching mask, to form a hard mask pattern on the etching-target film; and etching the etching-target film using the hard mask pattern as the etching mask.

### BRIEF DESCRIPTION OF THE DRAWINGS

FIG. 1 presents a general structure of a conventional hard mask material;

FIG. 2 presents a general structure of a conventional hard mask material;

FIG. 3 is a graph illustrating conventional energy distribution of atoms of a conventional hard mask material; and

FIGS. 4A through 4C are sectional views illustrating the formation of a fine pattern according to some embodiments of the present invention.

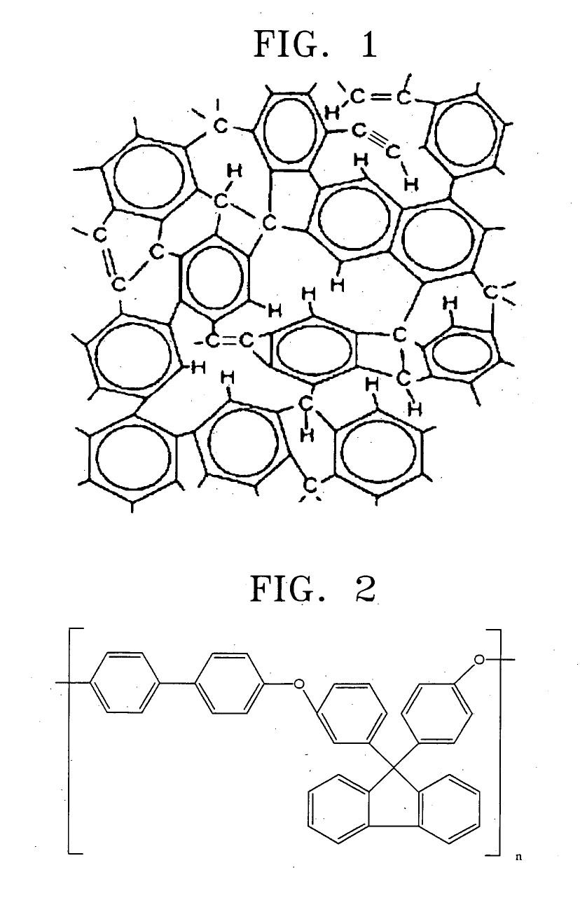

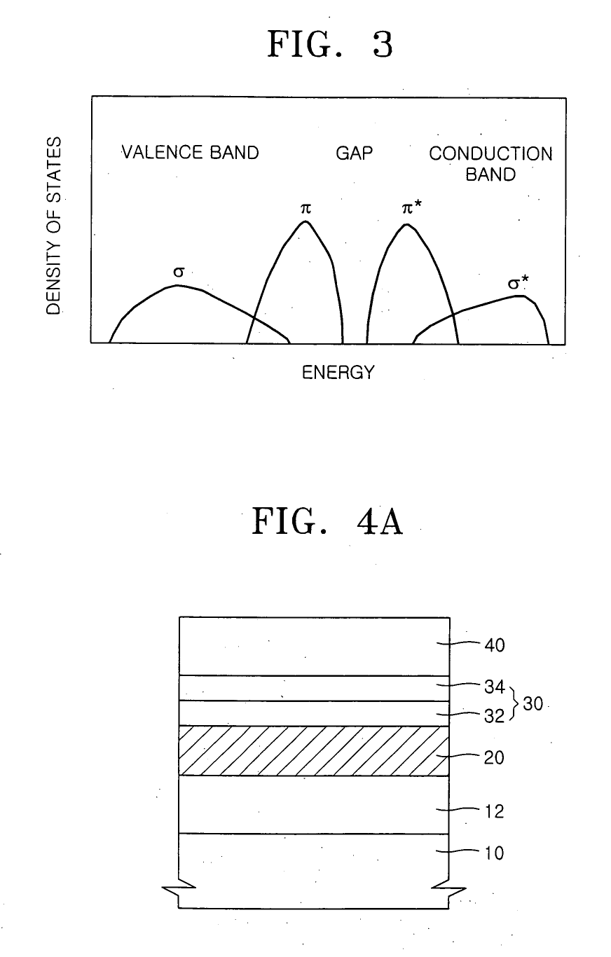

### DETAILED DESCRIPTION OF EMBODIMENTS OF THE INVENTION

The present invention will now be described more fully hereinafter with reference to the accompanying drawings, in which embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Unless otherwise defined, all terms, including technical and scientific terms used in this description, have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Moreover, it will be understood that steps comprising the methods provided herein can be performed independently or at least two steps can be combined. Additionally, steps comprising the methods provided herein, when performed independently or combined, can be performed at the same temperature and/or atmospheric pressure or at different temperatures and/or atmospheric pressures without departing from the teachings of the present invention.

In the drawings, the thickness of layers and regions are exaggerated for clarity. It will also be understood that when a layer is referred to as being “on” another layer or substrate or a reactant is referred to as being introduced, exposed or feed “onto” another layer or substrate, it can be directly on the other layer or substrate, or intervening layers can also be present. However, when a layer, region or reactant is described as being “directly on” or introduced, exposed or feed “directly onto” another layer or region, no intervening layers or regions are present. Additionally, like numbers refer to like compositions or elements throughout.

Embodiments of the present invention are further described herein with reference to cross-section illustrations that are schematic illustrations of idealized embodiments of the present invention. As such, variations from the shapes of the illustrations as a result, for example, of manufacturing techniques and/or tolerances, are to be expected. In particular, the regions illustrated in the figures are schematic in nature and their shapes are not intended to illustrate the precise shape of a region of a device and are not intended to limit the scope of the present invention.

As will be appreciated by one of ordinary skill in the art, the present invention may be embodied as compositions and devices including the compositions as well as methods of making and using such compositions and devices.

Some embodiments of the present invention provide polymeric films. In some embodiments, the polymeric film may be used for forming a hard mask. Polymeric films according to some embodiments of the present invention include a polymer having an sp³ carbon main frame including a tetrahedral center atom in contrast to the conjugated sp² carbon structure that may be present in conventional polymers that may be used in methods of forming a hard mask.

In some embodiments of the present invention, the polymeric film includes a poly(hydridocarbyne) formed in a carbon compound repeating unit expressed by the following chemical formula 1:

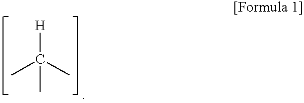

In some embodiments of the present invention, the polymeric film includes a carbon compound repeating unit expressed by the following chemical formula 2: 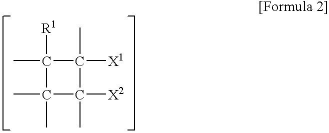
wherein:

R¹ includes an aliphatic, alicyclic or aromatic group having a general formula of C_{n′}H_{(2n′+1)} or C₆HₘR²₍₅₋ₘ₎, wherein R² includes a halide, hydroxy, nitryl or carboxyl group, n′ denotes an integer from 5 to 15 and m denotes an integer from 0 to 5; and

X¹ and X² independently include a Group VII halogen such as fluorine (F), chlorine (Cl), bromine (Br) or iodine (I), respectively.

In some embodiments, the carbon compound repeating unit may repeat as many times as allowable under the conditions provided. In some embodiments, the carbon compound repeating unit may repeat as many times as 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 or more.

In some embodiments, the polymeric hard mask film includes a carbon-rich film having at least about 70% carbon content by weight. The polymer including the sp³ carbon main frame including the tetrahedral center atom may be referred to as a diamond-like carbon (DLC), and may be conventionally obtained through a chemical vapor deposition (CVD). However, in the CVD process, relatively expensive deposition equipment may be employed, and the deposited film may present unsuitable conformality. Therefore, the conventional polymer may not be effective for use in the hard mask for manufacturing processes of semiconductor devices.

In contrast, the polymeric hard mask film according to some embodiments of the present invention can be formed using an organic liquid precursor in a spin coating method. Accordingly, the polymeric hard mask film according to some embodiments of the present invention may be formed with less difficulty than the DLC polymer in a film forming process. Further, as compared with a hard mask including a conjugated sp² amorphous carbon, the polymeric hard mask film according to some embodiments of the present invention may not π−π* transition, and thus, may not be associated with absorbance at longer wavelengths. Accordingly, there may be diminished misalignment in the interlayer alignment when the semiconductor device is manufactured employing the polymeric film according to some embodiments of the present invention in a hard mask.

In some embodiments, a method of forming the polymeric hard mask film is shown in the following chemical equation 1: 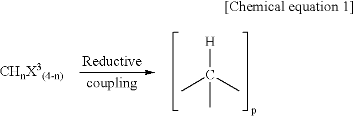
wherein

X³ includes a Group VII halogen such as fluorine (F), chlorine (Cl), bromine (Br) or iodine (I) and n and p are integers from 1 to 3.

In some embodiments, a method of forming the polymeric hard mask film is shown in the following chemical equation 2: 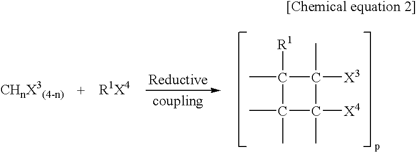
wherein

R¹ includes an aliphatic, alicyclic or aromatic group having a general formula of C_{n′}H_{(2n′+1)} or C₆HₘR²₍₅₋ₘ₎, R² includes a halide, hydroxy, nitryl or carboxyl group, n′ denotes an integer from 5 to 15 and m denotes an integer from 0 to 5;

X³ and X⁴ independently include a Group VII halogen such as fluorine (F), chlorine (Cl), bromine (Br) or iodine (I); and

n and p denote integers from 5 to 15.

In the chemical equations 1 and 2, the synthesizing processes are performed using a reductive coupling reaction. The reductive coupling reaction may be induced using a reaction including a metallic compound. In some embodiments, the metallic compound may include sodium kalium (NaK) or methyl lithium (MeLi). In some embodiments, heat, ultrasonic wave, light or a combination thereof can be used to promote the reductive coupling reaction in the chemical equations 1 and 2.

The resulting polymer can be dissolved in an organic solvent such as tetrahydrofuran (THF), methylene chloride (MC), toluene and the like, depending upon the nature of the R¹ group participating in the reductive coupling reaction or the amount of halide remaining in the resultant, as understood by one of skill in the art. Accordingly, the polymeric hard mask film according to some embodiments of the present invention can be spin-coated and formed on a substrate using an organic liquid dissolved in the organic solvent. After the polymeric hard mask film according to some embodiments of the present invention is spin-coated on the substrate, the coated polymeric film may be cured at a temperature in a range of about 200 to 300° C. for a period of time in a range of about 60 to 300 seconds to form a desired hard mask layer.

In some embodiments, a process of synthesizing and obtaining the polymer [I] using bromoform in the reductive coupling reaction of the chemical equation 1, and a pyrolysis process for reducing or eliminating the remaining bromine (Br) from the resulting polymer [I] are illustrated in the following chemical equation 3:

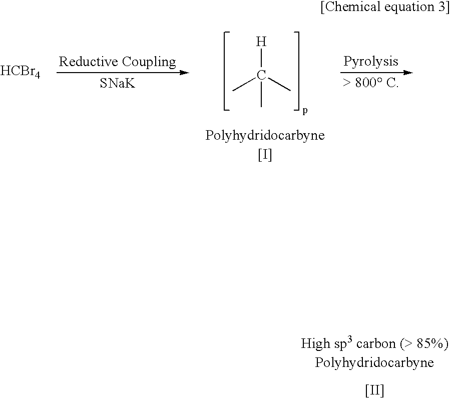

where p represents a desirable number of repeating units suitable under the conditions presented.

In some embodiments, in the chemical equation 3, sodium kalium (NaK) can be used to induce the reductive coupling reaction. The ultrasonic wave can be applied to promote the reductive coupling reaction. The polymer [I] obtained through the reductive coupling reaction may be a transition state material having a bromine (Br) remainder. If the polymer [I] is pyrolyzed at a temperature greater than about 800° C., the bromine (Br) remainder may be reduced or eliminated, and a carbon-rich poly(hydridocarbyne) (product [II]) may be obtained with more than about 85% sp³ carbon content including the tetrahedral center atom. The product [II] may be used as a precursor for forming the hard mask on the substrate in the spin coating method.

A process of synthesizing a polymer using carbon (IV) bromide (CBr₄) and aryl bromide can be performed on the basis of processes illustrated by chemical equation 2. A process of forming a polymeric hard mask film according to some embodiments of the present invention using the obtained polymer is illustrated in the process shown by chemical equation 4:

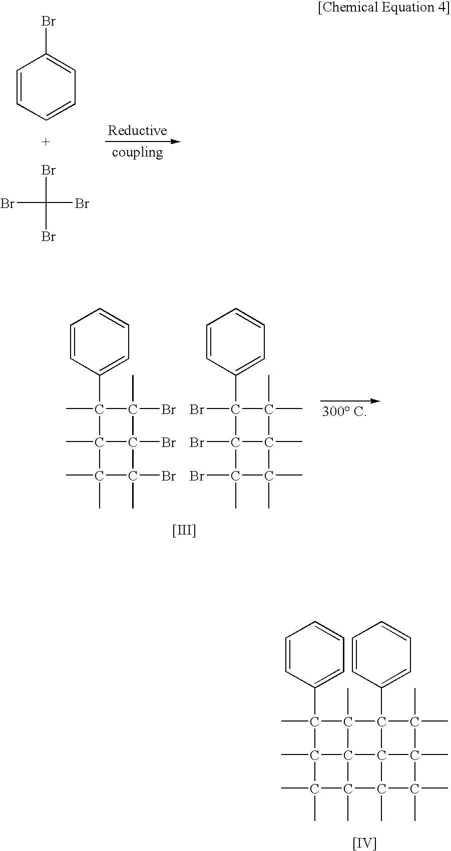

In chemical equation 4, the product [III] obtained through the reductive coupling reaction may be used as a precursor for forming the hard mask on the substrate in the spin-coating method. After the product [III] is spin-coated on the substrate, the coated product [III] may be cured at a temperature of about 330° C. to provide the product [IV]. In chemical equation 4, the product [IV] remains after the organic solvent is reduced or eliminated. The polymeric film including the remaining product [IV] may have decreased solubility with respect to the organic solvent.

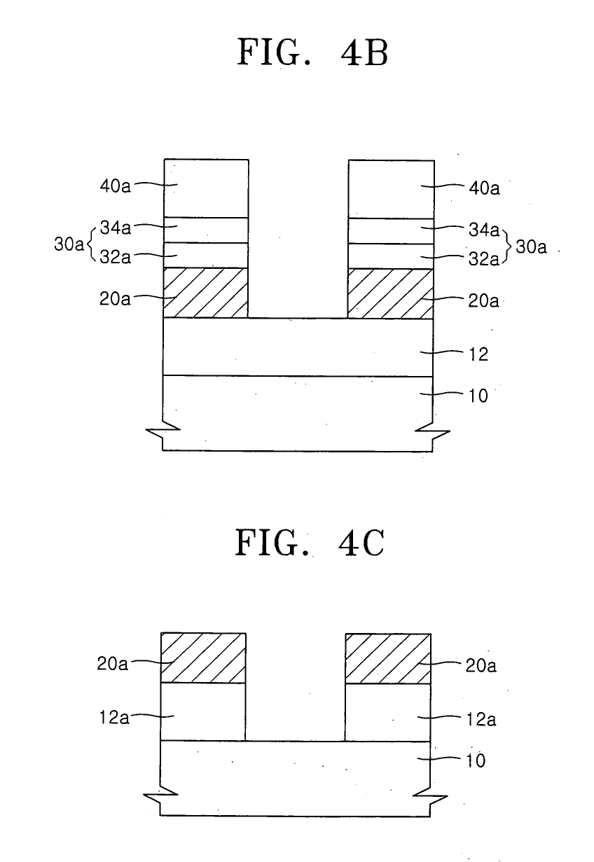

FIGS. 4A through 4C present sectional views illustrating a method for forming a fine pattern according to some embodiments of the present invention. Referring to FIG. 4A, an etching-target film 12 is formed on the semiconductor substrate 10. The etching-target film 12 may be formed of a material including silicon, such as silicon oxide, a silicon nitride, a silicon oxynitride or a derivative thereof, for example.

Subsequently, a hard mask layer 20 is formed including the polymeric hard mask film on the etching-target film 12. In order to facilitate formation of the hard mask layer 20, the polymeric film may be formed using the spin-coating method to provide the sp³ carbon main frame including the tetrahedral center atom. The polymeric film may be cured at a temperature in a range of about 200° C. to 300° C. A constituent material and a film forming method of the hard mask layer 20 were described previously, and therefore, will be omitted from further discussion.

An anti-reflective coating 30 is formed on the hard mask layer 20. The anti-reflective coating 30 may be formed of an inorganic anti-reflective coating, an organic anti-reflective coating, or a combination thereof. In this embodiment, the anti-reflective coating 30 may include the inorganic anti-reflective coating 32 and the organic anti-reflective coating 34. The inorganic anti-reflective coating 32 may include a material including silicon such as silicon oxynitride (SiON). The organic anti-reflective coating 34 can utilize a general commercial polymeric film having a refractive index and absorption coefficient suitable for formation of a photoresist at an exposure wavelength.

A photoresist film 40 may be formed on the anti-reflective coating 30. Referring to FIG. 4B, the photoresist film 40 is exposed and developed according to general methods known to those skilled in the art to form a photoresist pattern 40a.

Subsequently, the anti-reflective coating 30 and the hard mask layer 20 may be sequentially etched using the photoresist pattern 40a as an etching mask, to form a hard mask pattern 20a and an anti-reflective coating pattern 30a on the etching-target film 12. The anti-reflective coating pattern 30a includes an inorganic anti-reflective coating pattern 32a and an organic anti-reflective coating pattern 34a. FIG. 4B illustrates the photoresist pattern 40a and the anti-reflective coating pattern 30a, which may remain after the hard mask pattern 20a is formed. However, in some cases, when an etching process is performed to form the hard mask pattern 20a, the photoresist pattern 40a and the anti-reflective coating pattern 30a can be reduced or eliminated.

Referring to FIG. 4C, the etching-target film 12 is etched using the hard mask pattern 20a as the etching mask in order to form a desired fine pattern 12a. The hard mask pattern 20a includes the polymer having the sp³ carbon main frame including the tetrahedral center atom, and does not include the π−π* transition in its structure. Therefore, absorbance may not occur at longer wavelengths. Accordingly, when the semiconductor device is manufactured, performing the interlayer alignment may be facilitated. The polymer constituting the hard mask pattern 20a can have about 70% of carbon content by weight, thereby securing a sufficient resistance against the dry etching.

An experimental example presenting a method of forming a fine pattern using a polymeric hard mask pattern according to some embodiments of the present invention is described below. The present invention should not be limited in scope to the following example.

### EXAMPLE

A solution obtained by dissolving 10 g bromoform in 50 ml tetrahydrofuran (THF) was added to a 300 ml THF emulsion of NaK in an atmosphere of nitrogen, and was treated using the ultrasonic wave (475W, 20 KHz) for 30 minutes.

The reaction-completed solution was quenched using water. A solvent was eliminated to obtain a brown-color solid lump having a white-color pattern in part. Methylene chloride (MC) was added to the obtained solid lump to melt out the white-color pattern from the obtained solid lump. After about a 50% of the MC was evaporated, hexane was added in small doses to precipitate a brown-color polyhydrydocarbyne. Results of 1H nuclear magnetic resonance (NMR) and 13C NMR spectroscopy for the resulting compound are as follows.

¹H NMR: d 1.0-3.0, 1.59, 1.25

¹³C NMR: d 15, 30.1, 50-100, 114.8

The solution was prepared by dissolving 2 g of the resultant in 10 ml THF. After the solution was spin-coated at a thickness of 2000 Å on the substrate having a Si₃N₄ film thereon, the resultant was baked and cured at a temperature of 300° C. for 120 seconds. SiON for the inorganic anti-reflective coating, AR46 (manufactured by Shipley) for the organic anti-reflective coating, and RHR3640 (manufactured by ShinEtsu) for the photoresist film were sequentially coated to have thicknesses of 600 Å, 330 Å and 1600 Å, respectively, on the hard mask layer obtained as a result of curing and then pre-baked at a temperature of 110° C. for 60 seconds. Next, a line and space pattern was exposed at a dose amount of 20 mJ/cm² in S307D scanner (0.85NA, Annular 92/72 condition), and was post-baked at a temperature of 110° C. for 60 seconds. The resultant was then developed using a 2.38% TMAH (tetramethyl ammonium hydroxide) aqueous solution to form the photoresist pattern having a line width of 65.3 nm.

The organic anti-reflective coating (AR46) and the inorganic anti-reflective coating including silicon oxynitride (SiON) were dry-etched using the photoresist pattern as the etching mask. The hard mask layer was then dry-etched to form the hard mask pattern. After the silicon nitride (Si₃N₄) film was etched on the substrate using the hard mask pattern as the etching mask, the hard mask pattern remaining on the substrate was ashed and stripped to obtain a final Si₃N₄ pattern as desired.

While the present invention has been particularly shown and described with reference to some embodiments thereof, it will be understood by those of ordinary skill in the art that various changes in form and details may be made therein without departing from the spirit and scope of the present invention as defined by the following claims.

What is claimed is:

1. A polymeric film comprising a polymer having an sp³ carbon main frame further comprising a tetrahedral center atom.

2. The polymeric film of claim 1, wherein the polymer comprises a poly(hydridocarbyne) having a carbon compound repeating unit according to the following formula:

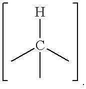

3. The polymeric film of claim 1, wherein the polymer comprises a carbon compound repeating unit according to the following formula: 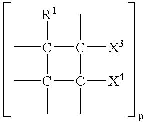
wherein:
R¹ is an aliphatic, alicyclic or aromatic group having a formula of C_{n′}H_{(2n′+1)} or C₆HₘR²₍₅₋ₘ₎, wherein R² is a halide, hydroxy, nitryl or carboxyl group, n′ is an integer from 5 to 15 and m is an integer from 0 to 5;
X¹ and X² are each independently a halogen; and
p is an integer from 1 to 15.

4. The polymeric film of claim 3, wherein X¹ and X² are each independently fluorine (F), chlorine (Cl), bromine (Br) or iodine (I).

5. The polymeric film of claim 1, wherein the polymeric film has at least about 70% carbon content by weight.

6. A method of forming a polymeric film, comprising:
forming the polymeric film comprising an sp³ carbon main frame further comprising a tetrahedral center atom, on a substrate; and
curing the polymeric film at a temperature in a range of about 200° C. to 300° C.

7. The method of claim 6, wherein the polymeric film comprises a poly(hydridocarbyne) comprising a carbon compound repeating unit according to the following formula:

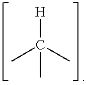

8. The method of claim 6, wherein forming the polymeric film further comprises carrying out a reductive coupling reaction of a compound having the following formula:
CHₙX³₍₄₋ₙ₎
wherein:
X³ is a halogen and n is an integer from 1 to 3.

9. The method of claim 8, wherein X³ is fluorine (F), chlorine (Cl), bromine (Br) or iodine (I).

10. The method of claim 8, wherein the reductive coupling reaction is induced by a reaction with a metallic compound.

11. The method of claim 10, wherein the metallic compound comprises sodium kalium (NaK) or methyl lithium (MeLi).

12. The method of claim 8, wherein the reductive coupling reaction is promoted using heat, ultrasonic wave, light or a combination thereof.

13. The method of claim 6, wherein the polymeric film comprises a carbon compound repeating unit according to the following formula: 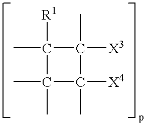
wherein:
R¹ is an aliphatic, alicyclic or aromatic group having a formula of CₙH₍₂ₙ₊₁₎ or C₆HₘR²₍₅₋ₘ₎, wherein R² is a halide, hydroxy, nitryl or carboxyl group, n is an integer from 5 to 15 and m is an integer from 0 to 5;
X¹ and X² are each independently a halogen; and
p is an integer from 1 to 15.

14. The method of claim 13, wherein X¹ and X² are each independently fluorine (F), chlorine (Cl), bromine (Br) or iodine (I).

15. The method of claim 13, wherein forming the polymeric film further comprises carrying out a reductive coupling reaction of two compounds according to the following formulas:
CHₙX³₍₄₋ₙ₎ (1)
wherein:
X³ is fluorine (F), chlorine (Cl), bromine (Br) or iodine (I) and n is an integer from 0 to 3; and
R¹X⁴ (2)
wherein:
R¹ is an aliphatic, alicyclic or aromatic group having a formula of C_{n′}H₍₂ₙ₊₁₎ or C₆HₘR²₍₅₋ₘ₎, wherein R² is a halide, hydroxy, nitryl or carboxyl group, n′ is an integer from 5 to 15 and m is an integer from 0 to 5; and
X⁴ is fluorine (F), chlorine (Cl), bromine (Br) or iodine (I).

16. The method of claim 15, wherein the reductive coupling reaction is induced by a reaction with a metallic compound.

17. The method of claim 16, wherein the metallic compound comprises sodium kalium (NaK) or methyl lithium (MeLi).

18. The method of claim 15, wherein the reductive coupling reaction is promoted using heat, ultrasonic wave, light or a combination thereof.

19. The method of claim 6, wherein the method of forming the polymeric film further comprises employing a spin-coating method.

20. The method of claim 6, wherein curing the polymeric film is performed for a period of time in a range of about 60 to 300 seconds.

21. A method of forming a fine pattern, comprising:
forming an etching-target film on a substrate;
forming a hard mask layer comprising a polymeric film comprising an sp³ carbon main frame further comprising a tetrahedral center atom, on the etching-target film;
forming an anti-reflective coating on the etching-target film;
forming a photoresist film on the anti-reflective coating;
exposing and developing the photoresist film to form a photoresist pattern;
sequentially etching the anti-reflective coating and the hard mask layer using the photoresist pattern as an etching mask, to form a hard mask pattern on the etching-target film; and
etching the etching-target film using the hard mask pattern as the etching mask.

22. The method of claim 21, wherein forming the hard mask layer further comprises:
employing a spin-coating method to form the polymeric film; and
curing the polymeric film at a temperature in a range of about 200° C. to 300° C.

23. The method of claim 21, wherein the polymeric film comprises a poly(hydridocarbyne) comprising a carbon compound repeating unit according to the following formula:

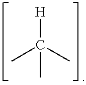

24. The method of claim 21, wherein the polymeric film comprises a carbon compound repeating unit according to the following formula: 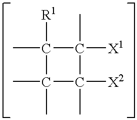
wherein:
R¹ is an aliphatic, alicyclic or aromatic group having a formula of C_{n′}H₍₂ₙ₊₁₎ or C₆HₘR²₍₅₋ₘ₎, wherein R² is a halide, hydroxy, nitryl or carboxyl group, n′ is an integer from 5 to 15 and m is an integer from 0 to 5; and
X¹ and X² are each independently a halogen.

25. The method of claim 24, wherein X¹ and X² are each independently fluorine (F), chlorine (Cl), bromine (Br) or iodine (I).

26. A hard mask comprising a polymeric film of claim 1.
